(19) United States
(12) Patent Application Publication
(10) Pub. No.: US 2025/0000612 A1
(43) Pub. Date: Jan. 2, 2025

(54) DENTAL RETAINER

(71) Applicant: LEONE S.P.A., Sesto Fiorentino (IT)

(72) Inventors: Gabriele SCOMMEGNA, Impruneta (IT); Tommaso BRIGANTI, Firenze (IT); Jasmine MARJOUEE, Firenze (IT)

(21) Appl. No.: 18/708,614

(22) PCT Filed: Mar. 14, 2023
(86) PCT No.: PCT/IT2023/050078

§ 371 Date: May 9, 2024

(30) Foreign Application Priority Data
Mar. 18, 2022 (IT) 102022000005336

(51) Int. Cl. A61C 5/00

(52) U.S. Cl. CPC A61C 5/007

(57) ABSTRACT

Dental retainer (1) configured to be applied on the lingual surface (L) of a predetermined number of teeth (T) of a dental arch (AD), comprising an adhesivation zone (2) anatomically configured to adhere to said lingual surface (L), and provided with an integrated positioner comprising positioning surfaces (22; 24) joined to the adhesivation zone (2) and spaced from the latter, said positioning surfaces (22; 24) being anatomically configured to come into contact with the respective teeth of the dental arch (AD) outside the adhesivation zone (2).

The present invention relates to a dental retainer.

It is known that a dental retainer is an appliance that can be used to maintain the results achieved by an active orthodontic treatment of repositioning or aligning the teeth. The retention phase conventionally follows that of active orthodontic treatment and is implemented to counteract the physiological tendency of the teeth to return to their initial positions once the appliance used for orthodontic treatment is removed, i.e. once the corrective forces applied to the teeth by the orthodontic appliance are removed. Generally, an orthodontic retainer consists of a body of predetermined shape and size cemented to the lingual surface of the teeth previously subjected to the orthodontic treatment. Typically, an orthodontic retainer extends along the lingual surface of the teeth in the area between the canines of the affected dental arch. Examples of orthodontic retainers of the type described above are provided in EP3162321A1, WO2004/028394A1, WO2017/198514A1, WO2018/092052A1, WO2014/140013A1, US2005/0181332A1, US2020/0197133A1, US2020/0197132A1, WO2020/178353A1 and US2021/0307877. Further examples of dental retainers are described in U.S. Pat. No. 3,395,455A1, US2021/251730A1, U.S. Pat. No. 4,609,350A, KR2021 0152871 A, U.S. Pat. No. 4,413,978A, RU2579743C1 and US2020/229903A1.

An orthodontic retainer can generally be made by means of manual shaping, machine tools, injection moulding or additive manufacturing techniques such as 3D printing. In order to more accurately detect the morphology of the dental arches, and to more precisely conform the retainer to the dental arches, an intra-oral scanner can be used to obtain a digital three-dimensional model of the patient's dental arches and soft tissues, and the generation of a file that can be used, for example, to control a 3D printer or other machine tool with which the orthodontic retainer is made.

A problem that is still felt is related to the fact that the positioning of an orthodontic retainer, whose shape is closely related to the position of the teeth previously achieved with the active orthodontic treatment, strongly influences its action. In fact, if incorrectly positioned, the orthodontic retainer may provoke a result opposite to the desired one, thus nullifying the active orthodontic treatment previously performed, even if the shape of the orthodontic retainer exactly corresponds to the morphological profile of the teeth in the area of application of the retainer.

The main aim of the present invention is to overcome the aforementioned drawbacks.

In accordance with the present invention, this has been achieved by adopting the idea of making a device having the features indicated in claim 1. Other features of the present invention are described in the dependent claims.

Thanks to the present invention, it is always possible to correctly position the dental retainer, thereby drastically reducing the risk that the application of this device will nullify the results obtained by an active orthodontic treatment previously performed on the same patient. Furthermore, a dental retainer in accordance with the present invention can be used with the utmost ease by the dentist. A further advantage lies in the possibility of fabricating the present dental retainer on the basis of a digital three-dimensional model of the patient's arches. Furthermore, thanks to the possibility of correctly positioning the dental retainer, it is possible to use less adhesive, or cement, minimising the possibility of detachment over time also thanks to the reduced thickness of the adhesive that is used. These and further advantages and features of the present invention will be more and better understood by any person skilled in the art thanks to the following that follows and to the attached drawings, provided as an example but not to be considered in a limiting sense, in which

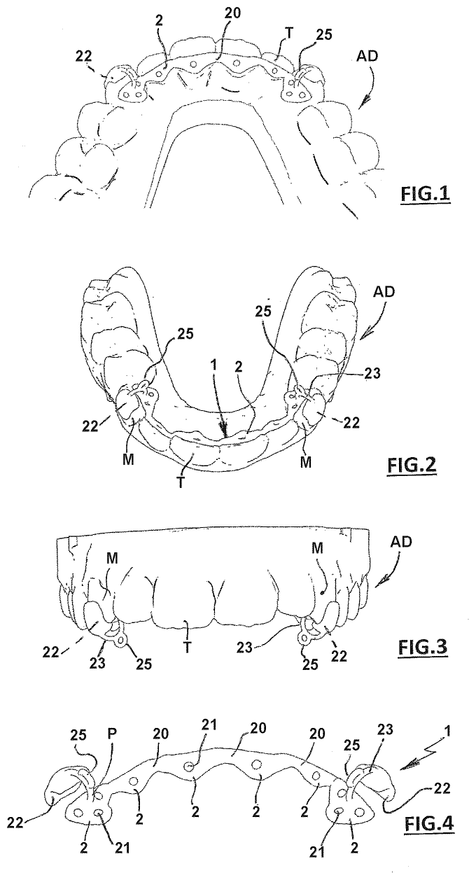

FIGS. 1-3 represent three views of a dental retainer in accordance with the present invention in a position of application to a dental arch;

FIG. 4 represents a perspective view of the dental retainer of FIGS. 1-3;

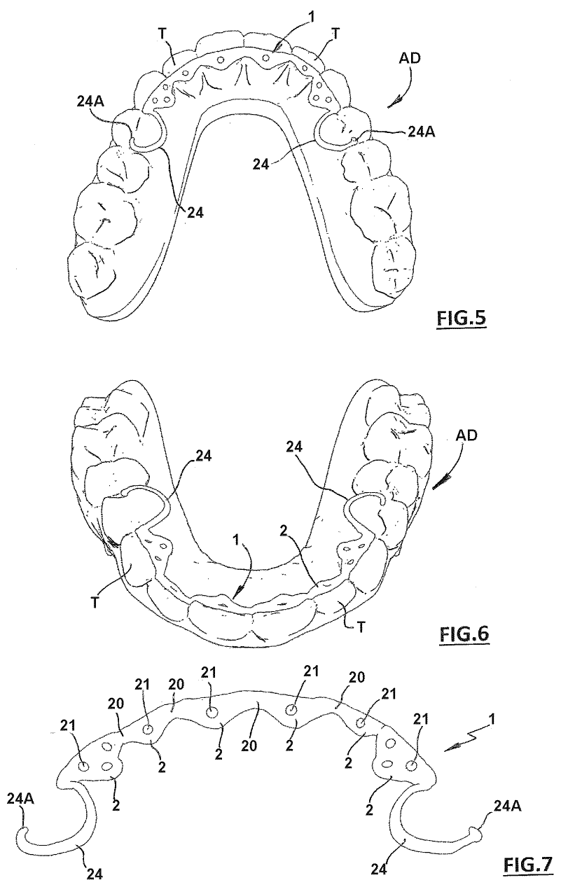

FIGS. 5-6 represent two views of a dental retainer in accordance with a further embodiment of the present invention in a position of application to a dental arch

FIG. 7 is a perspective view of the dental retainer of FIGS. 5-6;

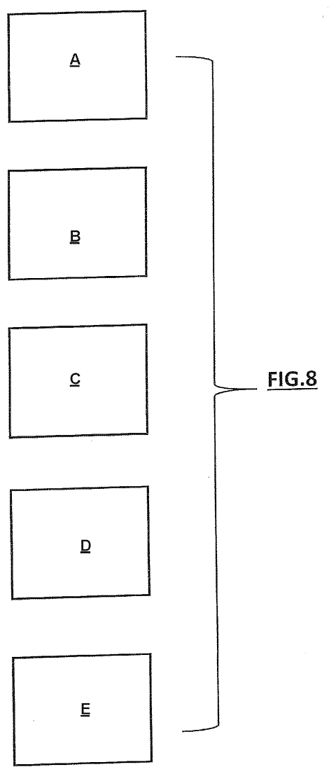

FIG. 8 is a diagram representing a sequence of possible steps in the production of a dental retainer in accordance with the present invention.

A dental retainer (1) in accordance with the present invention is made to be applied to the lingual surface (L) of a predetermined number of teeth (T) of a dental arch (AD) and can be customised to match the lingual surface of the teeth to which it is applied.

More particularly, a dental retainer in accordance with the present invention comprises an adhesion zone to the lingual surface of the affected teeth.

For example, said adhesion zone comprises a plurality of interconnected adhesion surfaces (2), each of which is anatomically configured to be adhered to the lingual surface of a respective tooth.

In accordance with the examples shown in the accompanying drawings, said adhesion surfaces (2) are connected to each other by connecting bridges (20) also configured to adhere to the surface of the teeth to which the dental retainer (1) is applied.

In particular, the adhesion surfaces (2) and said bridges (20) exhibit, on the side of adhesion to the teeth (T), a curvature corresponding to that presented by the lingual side of the respective teeth. The dental retainer (1) can be realized as a single element, i.e. as a single body, in which the adhesion surfaces (2) and said bridges (20) are made of the same material. Preferably, the adhesion surfaces (2) have openings (21) that facilitate their retention on the lingual surface of the teeth (T) using an adhesive or dental cement of the type commonly used to cement orthodontic appliances to teeth.

For example, the dental retainer (1) can be made of Cr—Co alloy, titanium, stainless steel and, more generally, any biocompatible material for orthodontic or dental use. Again, the dental retainer (1) can be made of PEEK or even zirconia to make it less visible.

A dental retainer (1) in accordance with the present invention can be made by any suitable manufacturing technique. For example, a dental retainer (1) in accordance with the present invention can be made by CNC milling, injection moulding, additive manufacturing.

For example, as illustrated in the diagram of FIG. 8, a dental retainer (1) in accordance with the present invention is made starting from an impression of the patient's oral cavity, in particular an impression of the relevant dental arch (step A) by means of an intra-oral scanner to obtain a digital three-dimensional model of the oral cavity at the end of an orthodontic treatment, whereupon (step B) the digital three-dimensional model thus obtained is used by CAD software to design the dental retainer on the basis of the scan made in the previous step. For example, the CAD software is the software called “3D Leone Designer” by the same applicant.

Step (A) can also be performed by acquiring the dental arch through a physical impression with the production of a model (e.g. plaster) and then using a laboratory scanner to digitise the model.

Then, after a validation phase of the design by the dentist (phase C), the dental retainer is manufactured (phase D) by a machine controlled by the dimensional and shape data produced by the CAD software. Such a machine may be, for example, a CNC machine tool, a 3D printer or an injection moulding machine. Similarly, the dental retainer (1) can be produced by selective laser melting, a technique already known for making dental equipment. Finally, the dental retainer (1) thus produced is cemented onto the patient's teeth (T) (step E).

In the context of this description, by “orthodontic treatment” it is meant a treatment for repositioning or aligning teeth using an orthodontic appliance.

Advantageously, the labial surface (M) of at least one, e.g. two, of the teeth (T) on whose labial surface the dental retainer (1) will then be applied is also acquired as exemplified above. For example, the labial surface of two canines of the affected dental arch is acquired. It is understood that the labial surface of more than two teeth of the affected dental arch may be acquired. Therefore, in a subsequent design phase of the dental retainer (1), provision is made for the realization of at least one further surface (22), having a shape corresponding to said at least one labial surface (M). Said further surface (22) is connected to the lingual adhesion zone (area of adhesion to the lingual side of the teeth) by a respective connecting arm (23). Referring to the example shown in the accompanying drawings, a dental retainer (1) in accordance with the present invention has two further surfaces (22).

The further surface (22) constitutes an univocal positional reference allowing the retainer (1) to be positioned on the lingual side of the teeth correctly, easily and quickly. In other words, the additional surface constitutes a guide to the correct positioning of the retainer (1).

In practice, the dentist positions the dental retainer (1) by fitting it on the concerned dental arch, such that the additional surfaces (22) are each in contact with the labial side of a respective tooth, after having applied the chosen cement on the lingual side of the teeth intended to receive the dental retainer (1). After cementing, the dentist will cut the arms (23) close to their base (P) thus removing the additional surfaces (22). In order to prevent the arms (23) from falling into the patient's oral cavity when they are removed, preferably these arms have an eyelet (25) through which can be passed a wire (not visible in the drawings) held by the patient or the dentist's assistant and pulled towards the outside of the patient's mouth.

Said arms (23) are elements that connect the actual dental retainer with the further surfaces (22). The latter are labial positioning surfaces because they are intended to come into contact with the labial side of one or more teeth (T).

From the foregoing description, it is apparent that a dental retainer in accordance with the example shown in FIGS. 1-4 comprises an adhesion zone with surfaces (2) configured to allow the dental retainer to adhere to the labial side of a plurality of teeth (T) of a dental arch, and further comprises at least one labial positioning surface (22) configured to come into contact with the labial side of a respective tooth of the same dental arch. The bonding area and said additional labial positioning surface (22) are two different parts of the dental retainer (1).

Referring to the example shown in FIGS. 5-7 of the accompanying drawings, the further surfaces consist of lingual appendages (24) formed on either side of the adhesion zone (2). The lingual appendages (24) come into contact with the respective lingual surfaces of the affected teeth near the dental collar to take advantage of the undercut anatomically present in that area of the teeth guiding the correct positioning of the retainer (1).

For example, the lingual appendages (24) are anatomically shaped to make contact with the lingual side of two premolars. The lingual appendages (24) may have a distal part (24A) that can be positioned in an anatomical depression of the occlusal surface of the premolars. Also in this example, the adhesion zone and the said further labial positioning surface (22) are two different parts of the dental retainer (1).

The arrangement of the additional surfaces (22; 24), which, as mentioned above, constitute an univocal position reference with respect to the teeth to which the dental retainer (1) is to be applied, determines the most correct positioning of the dental retainer and, at the same time, simplifies and speeds up such positioning. Furthermore, said additional surfaces (22; 24), being distanced from the bonding zone, i.e. not being coincident with the bonding zone, do not alter the ability of the dental retainer (1) to adhere correctly to the lingual side of the teeth (T).

In both examples described, the retainer (1) incorporates a positioner.

In the first example, the positioner consists of the labial surfaces (22) intended to be removed after cementing the retainer to the affected teeth. In the second example, the positioner consists of the lingual appendages (24). In both cases, the retainer (1) is provided with an integrated positioner comprising positioning surfaces (22; 24) joined to and spaced from the adhesion zone (2), said positioning surfaces (22; 24) being anatomically configured to come into contact with respective teeth (T) outside the adhesion zone (2). In the first example, the positioning surfaces (22) are labial positioning surfaces intended to be removed. In the second example, the positioning surfaces (24) are lingual positioning surfaces that do not necessarily need to be removed. An adhesion zone is defined as an area intended to be bonded to the lingual surface of the teeth. In this sense, the adhesion zone (2) is a zone for bonding the retainer (1) to the teeth.

In practice, a dental retainer (1) in accordance with the present invention is a body configured to be applied to the lingual surface (L) of a predetermined number of teeth (T) of a dental arch (AD), comprising an adhesion zone (2) anatomically configured to adhere to said lingual surface (L), and is provided with an integrated positioner comprising positioning surfaces (22; 24) joined to and distanced from said adhesion zone (2), said positioning surfaces (22; 24) being anatomically configured to come into contact with respective teeth of the dental arch (AD) externally to the adhesion zone (2).

From the foregoing description, it is also apparent that a dental retainer in accordance with the present invention may have one or more of the following features, even combined with each other:
said adhesion surfaces (2) are connected with each other by connecting bridges (20) also configured to adhere to the surface of the teeth to which the dental retainer (1) is applied;
the dental retainer (1) can be made as a single element, i.e. as a single body, wherein the adhesion surfaces (2) and the connecting bridges (20) are made of the same material;
the bonding surfaces (2) have openings (21) that facilitate the escape of excess adhesive, or cement, and its removal prior to the polymerisation thereof;
the labial positioning surfaces (22) are connected to the adhesion area of the dental retainer by respective arms (23);
said arms (23) are intended to be removed from the dental retainer at a stage subsequent to its application;
the positioning surfaces are surfaces (24) defined by lingual appendages formed at the sides of the adhesion zone (2).

A retainer (1) in accordance with the present invention can be used not only to maintain the alignment of teeth following orthodontic treatment as described above, but also to stabilise the teeth of patients suffering from parodontopathy, i.e. to perform the so-called tooth splinting.

In practice, the implementation details may, however, vary in an equivalent manner with respect to the individual elements described and illustrated, without departing from the idea of the solution adopted and therefore remaining within the limits of the protection granted by this patent in accordance with the following claims.

1) Dental retainer (1) configured to be applied on the lingual surface (L) of a predetermined number of teeth (T) of a dental arch (AD), comprising an adhesivation zone (2) anatomically configured to adhere to said lingual surface (L), characterized in that it is provided with an integrated positioner comprising positioning surfaces (22; 24) joined to the adhesivation zone (2) and spaced from the latter, said positioning surfaces (22; 24) being anatomically configured to come into contact with the respective teeth of the dental arch (AD) outside the adhesivation zone (2), said positioning surfaces (22; 24) being labial (22) or lingual (24) positioning surfaces that form an univocal positioning guide modelled on the anatomical conformation of the affected dental arch.

2) Dental retainer according to claim 1 characterized in that said adhesivation zone (2) is formed by surfaces connected to each other by connecting bridges (20) also anatomically configured to adhere to the surface of the teeth on which the dental retainer (1) is intended to be applied.

3) Dental retainer according to claim 2 characterized in that it consists of a single element, in which the surfaces that define the adhesivation zone (2) and the connecting bridges (20) are made of the same material.

4) Dental retainer according to claim 1 characterized in that the adhesivation zone (2) has a plurality of openings (21).

5) Dental retainer according to claim 1 characterized in that the positioning surfaces are labial positioning surfaces (22) connected to the adhesivation zone (2) by means of respective arms (23).

6) Dental retainer according to claim 5 characterized in that said arms (23) are configured to be removed from the retainer.

7) Dental retainer according to claim 5 characterized in that said arms (23) are provided with an eyelet (25).

8) Dental retainer according to claim 1 characterized in that the positioning surfaces are surfaces (24) defined by lingual appendages formed on the sides of the adhesivation zone (2).
